(19) United States
(12) Patent Application Publication
(10) Pub. No.: US 2016/0351997 A1
(43) Pub. Date: Dec. 1, 2016

(54) Mobile Phone Antenna System

(71) Applicants: Xiaopu Wu, Shenzhen (CN); Yongli Chen, Shenzhen (CN)

(72) Inventors: Xiaopu Wu, Shenzhen (CN); Yongli Chen, Shenzhen (CN)

(73) Assignee: AAC Technologies Pte. Ltd., Singapore city (SG)

(21) Appl. No.: 15/001,879

(22) Filed: Jan. 20, 2016

(30) Foreign Application Priority Data
May 29, 2015 (CN) 201520364687.7

(51) Int. Cl. H01Q 1/24; H01Q 5/335

(52) U.S. Cl. CPC H01Q 1/243; H01Q 5/335

(57) ABSTRACT

A mobile phone antenna system includes a metal rear cover, a circuit board, a first antenna module and a second antenna module connected electrically with the circuit board. The metal rear cover includes a top cover, a middle cover with a distance from the top cover, and a connector used for connecting electrically the top cover and the middle cover. The circuit board is provided with several grounding points. The top cover takes the connector as dividing point. The first antenna module and the second antenna module are connected electrically with the top cover at one side of the connector. A number of second match circuits are connected electrically with the grounding points, and the mobile phone antenna system has better adjusting ability.

### FIELD OF THE INVENTION

The present disclosure relates to mobile communication field, particular to a mobile phone antenna system.

### DESCRIPTION OF RELATED ART

With progressive development of mobile phone, tablet and other mobile devices, the requirement on the appearance of mobile terminal devices is increasingly high. Mobile phone with a metal housing, because of its texture and wear resistance, is favored by the majority of consumers.

The mobile phone with relevant technologies usually includes a metal housing and several antenna structures in the metal housing. These antenna structures located in the metal housing take usually metal ring or metal cap on the metal housing as the radiator of the antenna. The antenna covers more frequency bands by means of opening more slits on the metal cover or increasing antenna's quantity. These means will affect the overall appearance of the metal cover, also increase the design difficulty of antenna. The isolation between several antenna structures is relatively poor.

Therefore, it is necessary to provide a new mobile phone antenna system to overcome the problems mentioned above.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a partially exploded view of a mobile phone antenna system in accordance with an exemplary embodiment of the present disclosure.

FIG. 2 is an enlarged view of Part A in FIG. 1.

FIG. 3 is a structural diagram of the mobile phone antenna system in FIG. 1.

### DETAILED DESCRIPTION OF THE EXEMPLARY EMBODIMENT

The present invention will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

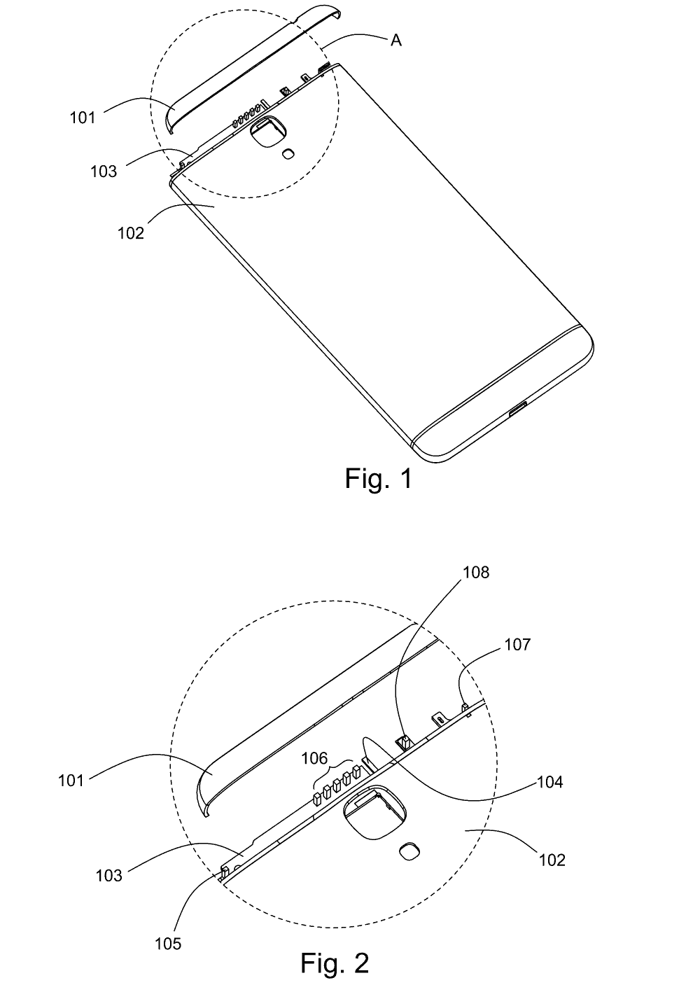

As shown in FIG. 1, a mobile phone antenna system 100, in accordance with an exemplary embodiment of the present disclosure, includes a metal rear cover, a circuit board 103, a first antenna module and a second antenna module electrically connected with the circuit board 103. The metal rear cover includes a top cover 101, a middle cover 102 keeping a distance from the top cover 101, and a connector 104 used for electrically connecting the top cover 101 and the middle cover 102. The circuit board 103 is provided with several grounding points (i.e. grounding points of the system). The middle cover 102 is connected electrically with the grounding points on the circuit board 103 at different positions. The distance between the top cover 101 and the middle cover 102 is 1 mm.

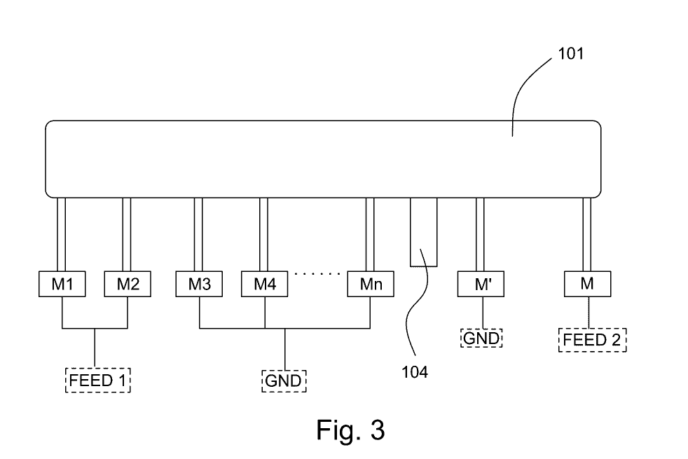

As shown in FIGS. 2 and 3, the first antenna module includes a first feed point 105, at least two first match circuits connected electrically with the first feed point 105 and second match circuits connected electrically with the grounding points. Optionally, two first match circuits, respectively M1 and M2, are used for providing power through M1 and M2. In a selected embodiment of this disclosure, the first antenna module is a WIFI & GPS antenna. In other words, WIFI signal passes through M1 which is connected electrically with the first feed point 105 and GPS signal passes through M2. It is worth to be noticed here that the first match circuit is only a general name of the match circuit electrically connected with the first feed point 105. There may be several first match circuits and they are functionally different. One feed point is connected electrically with several first match circuits, thereby feeds several kinds of antennas, so that the space of the rear cover is saved and the antenna system can cover more frequency bands. There may be several second match circuits also, namely, M3, M4 . . . Mn. All the second match circuits are connected electrically with the grounding point of the system. As the first antenna module is connected electrically with the grounding point of the system through several second match circuits, the first antenna module has frequency selection function, so that the first antenna module has better adjusting ability.

The second antenna module includes a second feed point 107, a third match circuit M connected electrically with the second feed point 107 and a fourth match circuit M′ connected electrically with the grounding point of the system. In a selected embodiment of this disclosure, the second antenna module is a diversity antenna module.

It can be seen from FIG. 3 that the top cover 101 takes the connector 104 as a dividing point. The first match circuit and the second match circuit are connected electrically with the top cover 101 at one side of the connector 104. The third match circuit and the fourth match circuit are connected electrically with the top cover 101 at another side of the connector 104, which ensures the separation between the first antenna module and the second antenna module.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile phone antenna system including:
a metal rear cover including a top cover, a middle cover keeping a distance from the top cover, and a connector used for electrically connecting the top cover to the middle cover;
a circuit board includes a plurality of grounding points electrically connected to the middle cover;
a first antenna module connected electrically with the circuit board, the first antenna module including a first feed point on the circuit board, at least two first match circuits connected electrically with the first feed point, and a plurality of second match circuits connected electrically with the grounding point;
a second antenna module connected electrically with the circuit board; wherein
the top cover takes the connector as a dividing point, the first match circuit and the second match circuit are connected electrically with the top cover at one side of the connector.

2. The mobile phone antenna system as described in claim 1, wherein the second antenna module includes a second feed point on the circuit board, a third match circuit connected electrically with the second feed point and a fourth match circuit connected electrically with the grounding point, the third match circuit and the fourth match circuit are connected electrically with the top cover at the other side of the connector.

3. The mobile phone antenna system as described in claim 1, wherein the top cover and the middle cover define a distance of 1 mm.

4. The mobile phone antenna system as described in claim 1, wherein the first antenna module is a WIFI & GPS antenna.

5. The mobile phone antenna system as described in claim 4, wherein the second antenna module is a diversity antenna.
